(19) United States
(12) Patent Application Publication
(10) Pub. No.: US 2007/0100473 A1
(43) Pub. Date: May 3, 2007

(54) System and method for synchronization of isochronous data streams over a wireless communication link

(75) Inventors: William M. Shvodian, McLean, VA (US); Joel Z. Apisdorf, Reston, VA (US)

Correspondence Address: POSZ LAW GROUP, PLC, 12040 SOUTH LAKES DRIVE, SUITE 101, RESTON, VA, 20191, US

(73) Assignee: FREESCALE SEMICONDUCTOR INC., AUSTIN, TX (US)

(21) Appl. No.: 10/562,032

(22) PCT Filed: Jul. 1, 2004
(86) PCT No.: PCT/US04/17438

§ 371 Date: Dec. 22, 2005

Related U.S. Application Data
(60) Provisional application No. 60/483,629, filed on Jul. 1, 2003.

(51) Int. Cl. G05B 11/01

(52) U.S. Cl. 700/19; 701/213

(57) ABSTRACT

A transmitter (500) is provided for transmitting host data over a wireless channel. The transmitter (500) includes a free-running timer (560) that provides a series of increasing free-running timing values; a host interface circuit (510) that receives host data from a local host circuit and a first free-running timing value from the series of increasing free-running timing values; a detection circuit (530) for detecting a global synchronizing event and receiving a second free-running timing value from the series of increasing free-running timing values, and for placing the host data and the first free-running timing value into a host interface packet; and a wireless transceiver (530) for adding the second free-running timing value and an identifier for the global synchronizing event to the host interface packet to form an air link frame, and transmitting the air link frame over a wireless channel to a remote wireless device.

### CROSS-REFERENCE TO RELATED PATENT DOCUMENTS

This application relies for priority on U.S. provisional application Ser. No. 60/483,629, by William M. Shvodian et al., filed Jul. 1, 2003, entitled “SYNCHRONIZATION OF ISOCHRONOUS STREAMS OVER A WIRELESS COMMUNICATIONS LINK.”

### FIELD OF THE INVENTION

The present invention relates in general to wireless communication systems, such as ultrawide bandwidth (UWB) systems, including mobile transceivers, centralized transceivers, related equipment, and corresponding methods. Another aspect of the present invention relates to a wireless transceiver that can timestamp sensitive data packets with respect to a global synchronizing event such that timing of the data packets can be preserved in an efficient manner. This allows a wireless network to send data to one or more receiving devices in a way that allows the timing relationship of the transmitted packets to be maintained over an extended period of time.

### BACKGROUND OF THE INVENTION

In many wireless communication systems, it is important to keep careful track of the timing of certain time-sensitive data. In some wireless systems data is transmitted from a single transmitter to one or more receivers that must be received and processed in a particular order. For example, in a 1394 interface, it is necessary to preserve the timing relationship in a stream of data sent from a host to a local wireless transceiver and reproduce it on the stream of data sent from the local wireless transceiver to a remote wireless transceiver. The data to be transmitted is divided up into a stream of data frames that should be sent and processed in a particular order.

Examples of such time-sensitive systems include video and audio transmissions in which one or more devices may be receiving a video or audio transmission. This could involve an HSDI interface or any other appropriate host interface.

However, it can be difficult to maintain the timing of these data frames between multiple remote devices over a wireless link since the clock in every device will likely have a slightly different frequency. Although all devices in a given network will have clocks of the same nominal frequency, the actual frequency of their clocks will vary within an acceptable frequency range. And while this slight variation in frequency will not cause problems with internal signal processing, it can be disastrous with respect to coordinated timing.

Over time even slight differences in frequency will cause the timing between two devices to drift. And once the drift becomes too great, the timing of the data frames at the receiver cannot be guaranteed with respect to a transmitter device or any other receiver device. In this case, even if each individual device could properly order the incoming data frames, the set of receiving devices as a whole could not coordinate the timing between themselves.

This is particularly problematic when multiple devices should coordinate the same data transmission. One example of a circumstance that requires such coordination is if multiple speakers are listening for the same audio transmission. Their audio output should be coordinated to preserve the quality of the signal, and so the devices controlling each speaker must make certain that they process specific host data at the same time.

As a result, receiving radios could not adequately maintain the timing relationship with respect to the packets it receives. Therefore, it would be desirable to provide a method and related circuitry that would allow a wireless system to maintain timing between multiple devices and thereby allow the devices to properly order the data packets that they receive. It would also be desirable to provide a method to maintain timing between devices that does not degrade over time.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages in accordance with the present invention.

FIG. 1 is a block diagram of a transmitter device according to a first exemplary embodiment of the present invention;

FIG. 2 is a block diagram of a receiver device according to a first exemplary embodiment of the present invention;

FIG. 3 is a diagram of a host interface packet according to exemplary embodiments of the present invention;

FIG. 4 is a diagram of an air link frame according to a first exemplary embodiment of the present invention;

FIG. 5 is a block diagram of a transmitter device according to a second exemplary embodiment of the present invention;

FIG. 6 is a block diagram of a receiver device according to a second exemplary embodiment of the present invention; and

FIG. 7 is a diagram of an air link frame according to a second exemplary embodiment of the present invention.

### DETAILED DESCRIPTION OF PREFERRED EMBODIMENTS

One way to provide for accurate timing of data frames sent between devices in a wireless network is to use over-the-air timestamps that are referenced to a global synchronizing event. In this way, data that is sent over a wireless channel can be ordered in time in a way that will not deteriorate over time.

In a wireless network that uses periodic beacons, the beacons can be used as the synchronizing event. This takes advantage of an existing periodic signal (i.e., the beacon) that all participating devices in a network will already have to listen for. As a result, minimal additional circuitry and software will be required for maintaining synchronization of local clocks for purposes of the time-stamping of data.

### First Exemplary Embodiment

In a first exemplary embodiment a time stamp is provided with each data packet sent from a host interface. This time stamp includes a periodic signal identifier (e.g., a beacon number) and a time offset value with respect to that periodic signal identifier.

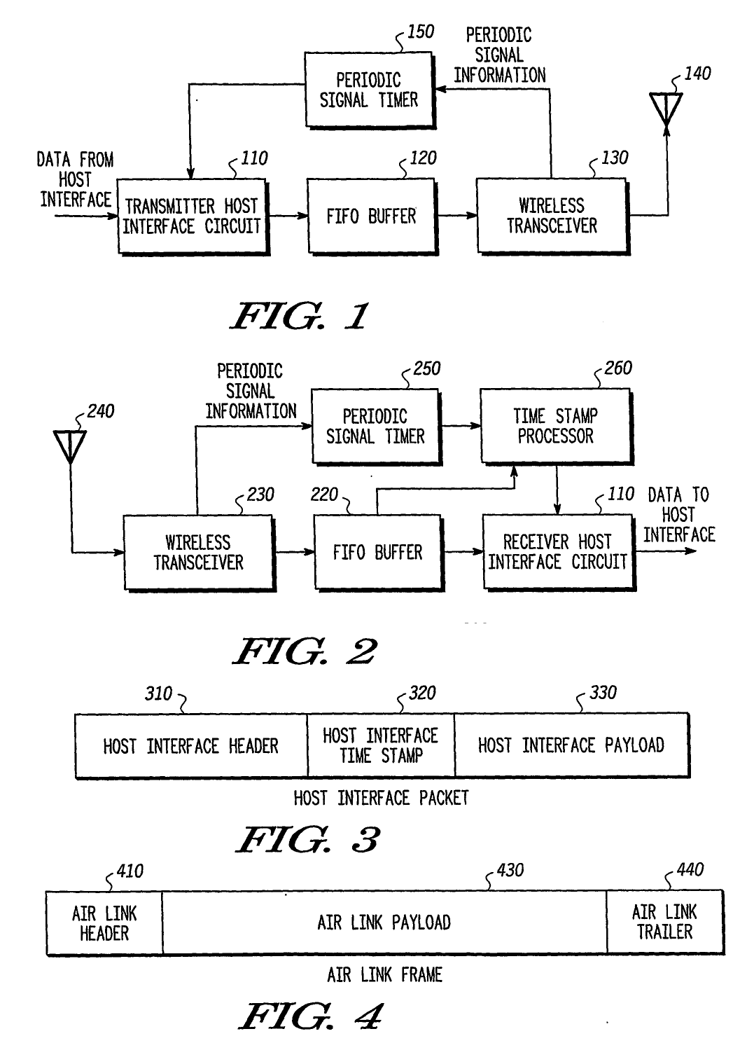

FIG. 1 is a block diagram of a transmitter device according to the first exemplary embodiment of the present invention. As shown in FIG. 1, the transmitting device 100 includes a transmitter host interface circuit 110, a first-in-first-out (FIFO) buffer 120, a wireless transceiver 130, an antenna 140, and a periodic signal timer 150.

The transmitter host interface circuit 110 receives host data packets from host circuitry (not shown) in the local transmitter device 100. These host data packets include data from the host in a format that a corresponding host at a remote receiver device could use (e.g. MPEG cells, MPEG cells encapsulated in a 1394 or HSDI format, Ethernet packets, internet protocol packets, PCM audio samples, etc.). The host data packets are provided in a particular order that the remote receiver device should process them in.

The transmitter host interface circuit 110 takes the host data packets and forms them into host interface packets that are ultimately sent to the radio transceiver for transmission. These host interface packets can include a single host data packet, can include a portion of a fragmented host data packet, or can include multiple aggregated host data packets. The process of fragmentation and aggregation would be understood by one skilled in the art and will not be described in detail here.

In forming the host interface packets, the transmitter host interface circuit 110 adds a time stamp to each host interface packet, which serves as an indicator of when the packet should be processed by a remote receiver device relative to other host interface packets. This time stamp may include a periodic signal identifier (e.g., a beacon number) and a time offset value with respect to that periodic signal identifier.

The transmitter FIFO buffer 120 receives host interface packets from the transmitter host interface circuit 110 and holds them for transmission by the wireless transceiver 130 in the order in which they are received.

The wireless transceiver 130 receives the series of host interface packets from the FIFO buffer 120, forms them into air link frames, and transmits the air link frames to one or more remote devices. Each air link frame can include a single host interface packet, several aggregated host interface packets, or a portion of a fragmented host interface packet, depending upon whether aggregation or fragmentation is used.

In the first exemplary embodiment the wireless transceiver 130 is an ultrawide bandwidth (UWB) transceiver. However, in alternate embodiments other sorts of transceivers could be used. For example, this time-stamping process could be used with wideband or narrowband transceivers as well.

The antenna 140 is used to transmit the air link frames, and can be any sort of appropriate wireless antenna. In the exemplary embodiment of FIG. 1, the antenna 140 is a UWB antenna of the sort disclosed in U.S. Pat. No. 6,590,545 to McCorkle, entitled “ELECTRICALLY SMALL PLANAR UWB ANTENNA APPARATUS AND SYSTEM THEREOF.” However, alternate embodiments could use other UWB antennas, or other appropriate antennas (e.g., wideband or narrowband antennas) as desired.

The periodic signal timer 150 is used to monitor the timing of the current periodic signal (e.g., the current beacon), and to provide the transmitter host interface circuit 110 with the time stamp information required to set the time stamps for the host interface packets it generates.

In exemplary embodiments, the transmitter device 100 in FIG. 1 uses a periodic beacon signal for time stamping, alternate embodiments could use other sorts of periodic signals. In such an alternate embodiment, the periodic signal timer 150 would monitor whatever sort of periodic signal was used.

For example, in one alternate embodiment a periodic signal from a satellite (e.g., a global positioning system signal) could be used for referencing the time stamps. In this case, the wireless transceiver 130 and the antenna 140 should be designed such that they can not only send the air link frames, but that they can also receive the periodic signal. In this alternate embodiment, the wireless transceiver 130 will provide the periodic signal timer 150 with the periodic signal information necessary to provide time stamps with respect to the alternate periodic signal (e.g., with respect to the global positioning system signal in this alternate embodiment).

FIG. 2 is a block diagram of a receiving device according to a first exemplary embodiment of the present invention. As shown in FIG. 2, the receiver device 200 includes a receiver host interface circuit 210, a FIFO buffer 220, a wireless transceiver 230, an antenna 240, a beacon timer 250, and a time stamp processor 260.

The antenna 240 receives wireless signals containing air link frames and provides the signals to the wireless transceiver 230. In the exemplary embodiment of FIG. 2, the antenna 240 is a UWB antenna of the sort disclosed in U.S. Pat. No. 6,590,545 to McCorkle, entitled “ELECTRICALLY SMALL PLANAR UWB ANTENNA APPARATUS AND SYSTEM THEREOF.” However, alternate embodiments could use other UWB antennas, or other appropriate antennas (e.g., wideband or narrowband antennas) as desired.

The wireless transceiver 230 receives the signals from the antenna 240, formed in air link frames, and extracts the host interface frames. If necessary, the wireless transceiver 230 splits up aggregated host interface frames or puts together fragmented host interface frames. Regardless, the resulting host interface frames are then sent by the wireless transceiver 230 to the FIFO buffer 220.

In the first exemplary embodiment the wireless transceiver 230 also receives the periodic signal (e.g., the beacon) and provides periodic signal information to the periodic signal timer 250.

The receiver FIFO buffer 220 receives a series of host interface frames from the wireless transceiver 230 and releases them one-by-one to the host interface circuit 210 in response to instructions from the time stamp processor 260.

The receiver host interface circuit 210 accepts the host interface frames from the FIFO buffer 220, extracts the host data frames, and provides these host data frames to host circuitry (not shown) in the receiver device 200.

The periodic signal timer 250 receives periodic signal information (e.g., the timing of the beacons) from the wireless transceiver 230, and provides the time stamp processor 260 with information used to control the release of host interface packets from the FIFO buffer 220.

The time stamp processor 260 includes a free-running timer and a memory. This memory stores a maximum latency value for transmitted signals and a receive time for each periodic signal. The maximum latency value is indicative of the maximum expected time for an air link data frame to pass from one device to another in the wireless network. The receive time for each periodic signal indicates when each respective periodic signal was received by the receiver device 200.

In an embodiment in which the period of the periodic signal is fixed or otherwise predictable, the time stamp processor 260 need not store a receive time for each periodic signal, but can calculate it mathematically based on an identifier of periodic signal and a knowledge of the period of the periodic signal. For example, if the period of the periodic signal is fixed at 100 μsec, then the time for an (n+k)^{th} periodic signal is the time for the n^{th} periodic signal plus (100*k) μsec. This time reference for the (n+k)^{th} periodic signal combined with an offset value will allow the receiver device 200 to adjust its timing appropriately.

The increments used by the time stamp processor 260 can vary in different embodiments, but should be small enough that sequential host interface packets will have different periodic signal offset values. In exemplary embodiments the timer increments are on the order of microseconds or 1/10 of a microsecond, although some embodiments could require finer resolution.

Although both FIGS. 1 and 2 disclose the use of transceivers 130 and 230, they can be replaced with just a transmitter or receiver in alternate embodiments. For example, if the transmitter device 100 is also the source of the periodic signal (e.g., it is the coordinating device that sends out the beacon), then in some embodiments it may only need to have a wireless transmitter in place of the wireless transceiver 130, if it need not listen for any other signals. Likewise if the receiver device 200 acts only as a receiver and has no need to transmit any signals, the wireless transceiver 230 may be replaced with a wireless receiver.

In operation, the transmitter device 100 and the receiver device 200 operate as follows. The host circuitry in the transmitter device 100 provides the transmitter host interface circuit 110 with a stream of host data frames. The transmitter host interface circuit 110 forms these host data frames into a stream of host interface frames.

FIG. 3 is a diagram of a host interface packet according to exemplary embodiments of the present invention. As shown in FIG. 3, the host interface packet 300 includes a host interface header 310, a host interface time stamp 320, and a host interface payload 330.

The host interface header 310 includes information necessary to identify the packet. It should have sufficient information to extract and order the host data frames or frame portions in the payload 330. In exemplary embodiments, the host interface header 3 10 may include the length of the packet, a protocol identifier, or any other information necessary to process the packet 300.

The host interface time stamp 320 includes time stamp information for the current host interface frame 300. In the first exemplary embodiment this time stamp information includes a periodic signal identifier and an offset time. Preferably the time stamp information indicates when the host instructs the transmitter device 100 to send a host data packet, not necessarily when the transmitter device 100 grabs the host data packet. (These two times may differ in some embodiments.) However, alternate embodiments may use any predictable time desired for setting the time stamp information, so long as it is consistent between the devices in a network. In other words, the host interface time stamp 320 can be linked to any particular moment, so long as it the receiving device can use that time as a proper indicator for release of a host interface packet 300.

In this embodiment the host interface time stamp 32 can be a 16-bit periodic signal identifier combined with a 16-bit offset value, accurate to within 0.1 μsec, although 1 μsec accuracy may be adequate in some embodiments, although some embodiments could require finer resolution.

The periodic signal identifier is an indicator for the most recently received periodic signal. In the first exemplary embodiment this is a beacon identifier for the beacon most recently received by the transmitter device 100 (or transmitted by the transmitter device 100 if the transmitter device 100 is also a coordinator device for the network). The offset time is an indicator of the period of time since the transmitter device 100 received (or transmitted, if appropriate) the most recent beacon.

Together, these two pieces of information provide time stamp information for a host interface packet. And since the host interface time stamp information is relative to a global periodic signal (e.g., the beacon), it can be coordinated among multiple receiving devices.

The host interface payload 330 contains one or more host data packets, or a fraction of a host data packet, depending upon whether aggregation or fragmentation of the host data packets is used.

After the transmitter host interface circuit 110 creates a host interface packet 300, this packet 300 is provided to the FIFO buffer 120, which outputs the packets 300 sequentially to the wireless transceiver 130, which, in turn, inserts the host interface packets 300 into air link frames.

FIG. 4 is a diagram of an air link frame according to a first exemplary embodiment of the present invention. As shown in FIG. 4, the air link frame 400 of this embodiment includes an air link header 410, an air link payload 430, and an air link trailer 440.

The air link header 410 includes information necessary to identify the air link frame 400. It should have sufficient information to extract and order the host interface frames 300 or frame portions in the air link payload 430. In exemplary embodiments, the air link header 410 may include a frame length, a destination address (for one or more destination devices), a stream index, or any other piece of data necessary for routing and processing the frame 400.

The air link payload 430 contains one or more host interface packets 300, or a fraction of a host interface packet 300, depending upon whether aggregation or fragmentation of the host interface packets is used.

The air link trailer 440 includes information used to improve the functionality of the air link frame 400. This may include a frame check sequence (FCS), an error correction code, or the like.

Once the wireless transceiver 130 in the transmitter device 100 has created an air link frame 400, it sends that frame 400 via the antenna 140 in the transmitter device 100 across a wireless channel to the antenna 240 and wireless transceiver 230 in the receiver device 200.

In the transmitter device 100, the periodic signal timer 150 knows when a new periodic signal starts, and can increment a periodic signal counter (e.g., a beacon counter), and reset the offset value to zero when this happens (or when it should happen).

The wireless transceiver 230 in the receiver device 200 extracts the host interface packets out of the air link payloads 430 of the air link frames 400 and sends them to the FIFO buffer 220. The wireless transceiver 230 also receives periodic signal information (e.g., from a periodic beacon) and sends the periodic signal information to the periodic signal timer 250. This can be beacon timing or information about whatever appropriate periodic timing signal is used.

The periodic signal timer 250 provides signals to the time stamp processor 260 that provide a periodic signal indicator (e.g., the beacon number) and a current offset time. This allows the time stamp processor 260 to determine a correction value to adjust its offset time with respect to a given periodic signal with respect to the offset time of the transmitter device 100.

The time stamp processor 260 uses the offset correction value in conjunction with a maximum expected latency value and the time stamp information from the oldest host interface packet in the FIFO buffer 220, to determine when the oldest host interface packet should be released to the receiver host interface circuit 210. The time stamp processor uses either a knowledge of the period of the periodic signal or a knowledge of the receive times of prior periodic signals to determine the appropriate releaser time.

In the embodiment disclosed in FIG. 2, the time stamp processor 260 instructs the receiver host interface circuit 210 when it should pull a new host interface packet 300 from the FIFO buffer 220. However, alternate embodiments could easily have the time stamp processor 260 provide a signal directly to the FIFO buffer 220 instructing it when to release its next host interface packet 300 to the receiver host interface circuit 210.

The time stamp processor 260 determines when the oldest packet 300 in the FIFO buffer 220 should be passed to the receiver host interface circuit 210 by adding the maximum latency value to the corrected offset time from the periodic signal indicated in the oldest host interface packet. This corresponds to the earliest time that the time stamp processor 260 is relatively certain that the packet 300 must have arrived at any other device that is also receiving it. This means that even if the current receiver device 200 has received a host interface packet 300 quickly, it will wait until the maximum expected latency time has passed before releasing the host interface packet 300 to the host.

When the host interface circuit 210 receives the next host interface packet 300, it then extracts the host data packet and sends it onward to the host (not shown) in the receiver 200 for processing.

In this embodiment it is necessary for the receiver device 200 to understand that the because the offset value us repeatedly reset to zero, the periodic signal identifier must be used in conjunction with the offset value to determine when a host interface packet 300 should be released. In other words, it might be necessary to release a packet 300 with a high offset value but a low periodic signal identifier before releasing a packet with a lower offset value but a higher periodic signal identifier.

Although the information passed from the host to the transmitter host interface circuit 110 is described as being a host interface packet and the information transmitted by the wireless transceiver 130 is described as being an air link frame, the terms “frame” and “packet” can be used interchangeably in each case, and should not be interpreted in any way as limiting the scope of the attached claims. However, for the sake of clarity in this disclosure, the term “packet” will be used to describe the signals sent from the host interface 110 and the term “frame” will be used to describe the signals transmitted by the wireless transceiver 130.

### Second Exemplary Embodiment

In a second exemplary embodiment a time stamp is provided with each host interface packet sent from a host interface, and with each air link frame sent from a wireless transceiver. The time stamp for each host interface packet includes a time value taken from a free-running clock at the transmitting device. The time stamp for each air link frame includes a periodic signal identifier (e.g., a beacon number) and a time value from the free-running clock corresponding to that periodic signal identifier.

FIG. 5 is a block diagram of a transmitter device according to the second exemplary embodiment of the present invention. As shown in FIG. 5, the transmitting device 500 includes a transmitter host interface circuit 510, a transmitter FIFO buffer 120, a wireless transceiver 530, an antenna 140, and a transmitter free-running timer 560.

The transmitter host interface circuit 510 receives host data packets from host circuitry (not shown) in the local transmitter device 500. These host data packets include data from the host in a format that a corresponding host at a remote receiver device could use. The host data packets are provided in a particular order that the remote receiver device should process them in.

The transmitter host interface circuit 510 takes the host data packets and forms them into host interface packets that are ultimately sent to the wireless transceiver 530 for transmission. These host interface packets can include a single host data packet, a portion of a fragmented host data packet, or multiple aggregated host data packets. The process of fragmentation and aggregation would be understood by one skilled in the art and will not be described in detail here.

In forming the host interface packets, the transmitter host interface circuit 510 adds a time stamp to each host interface packet that serves as an indicator of when it should be processed by a remote receiver device relative to other host interface packets. This time stamp includes a time value obtained from the free-running timer 560.

The transmitter FIFO buffer 120 receives host interface packets from the transmitter host interface circuit 5 10 and holds them for transmission by the wireless transceiver 530 in the order in which they are received.

The wireless transceiver 530 receives the series of host interface packets from the FIFO buffer 120, forms them into air link frames, and transmits the air link frames to one or more remote devices. Each air link frame can include a single host interface packet, several aggregated host interface packets, or a portion of a fragmented host interface packet, depending upon whether aggregation or fragmentation is used.

The air link frames also include an air link time stamp. In the second exemplary embodiment the air link time stamp includes a periodic signal identifier (e.g., a beacon number), and a time value from the free running timer 560 corresponding to the periodic signal identifier (i.e. a local counting clock value). The exact nature of the time value can vary, but this nature should be known to any receiving device. For example, the time value could correspond to the time that a periodic signal is received at the transmitter device 500, the time that a periodic signal is transmitted at the transmitter device 500, or some known timing position with respect to another type of global periodic event.

In alternate embodiments both the periodic signal and the time value used for the time stamp could vary. For example, the periodic signal indicator could identify a particular global positioning system (GPS) signal and the time value could indicate what a local counting clock read at the time when that particular GPS signal arrived at the transmitter device 500.

In this exemplary embodiment the wireless transceiver 130 is an ultrawide bandwidth (UWB) transceiver. However, in alternate embodiments other sorts of transceivers could be used. For example, this time-stamping process could be used with wideband or narrowband transceivers as well.

The antenna 140 is used to transmit the air link frames, and can be any sort of appropriate wireless antenna. In the exemplary embodiment of FIG. 5, the antenna 140 is a UWB antenna of the sort disclosed in U.S. Pat. No. 6,590,545 to McCorkle, entitled “ELECTRICALLY SMALL PLANAR UWB ANTENNA APPARATUS AND SYSTEM THEREOF.” However, alternate embodiments could use other UWB antennas, or other appropriate antennas (e.g., wideband or narrowband antennas) as desired.

The transmitter free-running timer 560 runs a continually incrementing clock that is used to time stamp the host interface packets output by the host interface circuit 510. The increments used by the transmitter free-running timer 560 can vary in various embodiments, but should be small enough that sequential packets will have different timer values. In exemplary embodiments the timer increments are on the order of 1/10 μsec to 1 μsec, although some embodiments could require finer resolution.

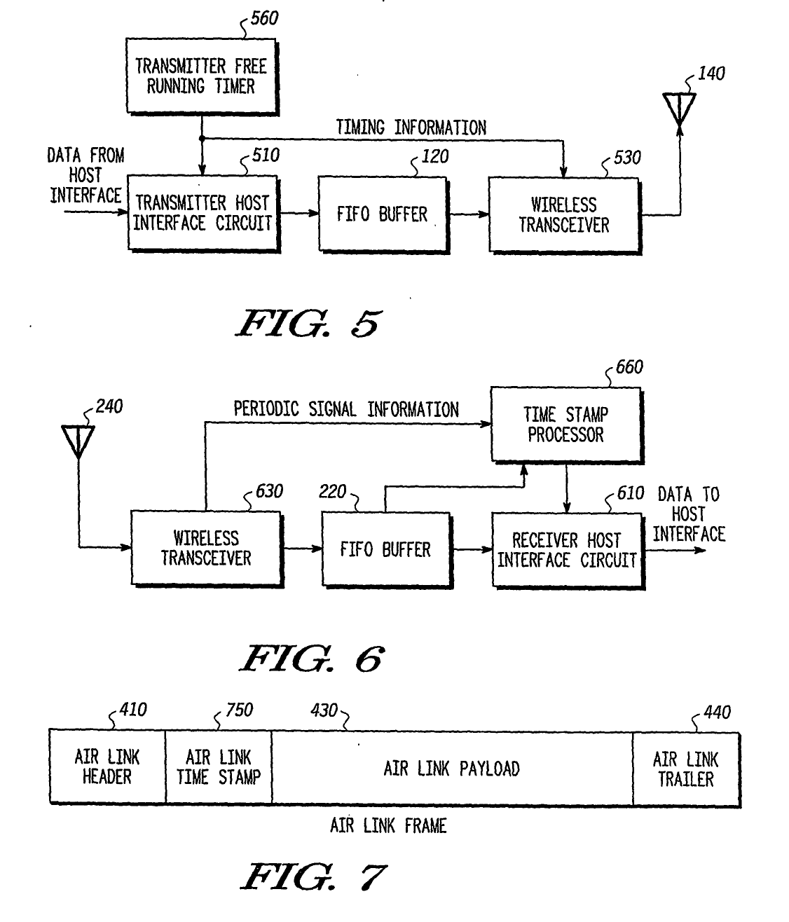

FIG. 6 is a block diagram of a receiver device according to a second exemplary embodiment of the present invention. As shown in FIG. 6, the receiver device 600 includes a receiver host interface circuit 610, a FIFO buffer 220, a wireless transceiver 630, an antenna 240, and a time stamp processor 660.

The antenna 240 receives wireless signals containing air link frames and provides the signals to the wireless transceiver 630. In the exemplary embodiment of FIG. 6, the antenna 240 is a UWB antenna of the sort disclosed in U.S. Pat. No. 6,590,545 to McCorkle, entitled “ELECTRICALLY SMALL PLANAR UWB ANTENNA APPARATUS AND SYSTEM THEREOF.” However, alternate embodiments could use other UWB antennas, or other appropriate antennas (e.g., wideband or narrowband antennas) as desired.

The wireless transceiver 630 receives the signals from the antenna 240, formed in air link frames, extracts host interface frames and air link time stamps from the air link frames 700. If necessary, the wireless transceiver 230 splits up aggregated host interface frames or puts together fragmented host interface frames. Regardless, the resulting extracted host interface frames are sent to the FIFO buffer 220.

The wireless transceiver 630 sends the extracted host interface frames to the FIFO buffer 220, and sends the periodic signal information (e.g., the beacon information) to the time stamp processor 660.

The receiver FIFO buffer 220 receives a series of host interface frames from the wireless transceiver 630 and releases them one-by-one in response to instructions from the time stamp processor 660.

The receiver host interface circuit 610 accepts the host interface frames from the FIFO buffer 220, extracts the host data frames, and provides these host data frames to host circuitry (not shown) in the receiver device 200.

The time stamp processor 660 includes a free-running timer and a memory. The free-running timer is a continually incrementing timer, preferably using the same increments as the transmitter uses. The memory stores timer information corresponding to the periodic signals received and a maximum latency value. The maximum latency value is a value indicative of the maximum expected time for an air link data frame to pass from one device to another in the wireless network.

The time stamp processor 660 receives air link time stamp information (e.g., beacon timing information) from the wireless transceiver 630 and host interface packet time stamp information from the oldest host interface packet in the FIFO buffer 220, and generates a signal to the receiver host interface 610 instructing it when to pull the oldest host interface packet in the FIFO buffer 220.

While FIG. 6 discloses a single time stamp processor 660, alternate embodiments could split the processing of the air link time stamp and the host interface time stamp into two separate circuits. Regardless, separate or together they operated functionally as a single time stamp processor 660.

Although both FIGS. 5 and 6 disclose the use of transceivers 530 and 630, they can be replaced with just a transmitter or receiver in alternate embodiments as appropriate. For example, if the transmitter device 500 is also the source of the periodic signal (e.g., it is the coordinating device that sends out the beacon), then in some embodiments it may only need to have a wireless transmitter in place of the wireless transceiver 530, if it need not listen for any other signals. Likewise if the receiver device 600 acts only as a receiver and has no need to transmit any signals, the wireless transceiver 630 may be replaced with a wireless receiver.

In operation, the transmitter device 500 and the receiver device 600 operate as follows. The host circuitry in the transmitter device 500 provides the transmitter host interface circuit 510 with a stream of host data frames. The transmitter host interface circuit 510 forms these host data frames into a stream of host interface frames, as shown in FIG. 3.

In the second exemplary embodiment, the host interface header 310 and the host interface payload 330 are preferably formed as disclosed above with regard to the first exemplary embodiment.

However, in the second exemplary embodiment, the host interface time stamp 320 includes just the value output from the transmitter free-running timer at a set time with respect to the processing of the host interface packet 300. Thus, in this embodiment the host interface time stamp 320 is simply the local time (as indicated by the transmitter free-running timer 560) that a given host interface packet 300 is processed.

In alternate embodiments, the set time could be any suitable time for coordinating the release of host data at a receiver device. Although typically it is the time at which a host in the transmitter device 500 provides host data to a host interface circuit 5 10, which is usually close to the time that the host data (within a host interface packet 300) is sent to the FIFO buffer 120, the particular timing can vary.

In this embodiment the host interface time stamp 320 can be a 32-bit free-running timer value, accurate to within 0.1 μsec, although 1 μsec accuracy may be adequate in some embodiments.

After the transmitter host interface circuit 510 creates a host interface packet 300, the packet 300 is provided to the FIFO buffer 120, which outputs the packets 300 sequentially to the wireless transceiver 530. The wireless transceiver 530 then inserts the host interface packets 300 into air link frames.

FIG. 7 is a diagram of an air link frame according to the second exemplary embodiment of the present invention. As shown in FIG. 7, the air link frame 400 includes an air link header 410, an air link time stamp 750, an air link payload 430, and an air link trailer 440.

The air link header 410, air link payload 430, and air link trailer 440 preferably operate as noted above with respect to the first exemplary embodiment, as shown in FIG. 4.

The air link time stamp 750 preferably includes information that will match the time of the periodic signal with the value output from the transmitter free-running timer 560. In an embodiment in which the periodic signal is a beacon, the air link time stamp 750 includes a periodic signal identifier (e.g., a beacon number) and the local time in the transmitter device 500 (as defined in the transmitter free-running timer 560) at which the periodic signal was received.

Once the wireless transceiver 530 in the transmitter device 500 has created an air link frame 700, it sends that air link frame 700 via the antenna 140 in the transmitter device 500 over a wireless channel to the antenna 240 and wireless transceiver 630 in the receiver device 600.

Upon receiving an air link frame 700, the wireless transceiver 630 in the receiver device 600 extracts the air link payload 430 and the air link time stamp 750 out of the air link frame 700. The wireless transceiver 630 sends the host interface packets 300 from the air link payload 430 into the FIFO buffer 220, and sends periodic signal information from the air link time stamp 750 to the time stamp processor 660.

The time stamp processor 660 then uses the periodic signal information in conjunction with a maximum expected latency value and the host interface time stamp information from the oldest host interface packet in the FIFO buffer 220, to determine when the oldest host interface packet should be released to the receiver host interface circuit 210.

The time stamp processor 660 includes a free-running timer and stores information regarding what local time the receiver device 600 received any given periodic signal (e.g., when it received each beacon). The time stamp processor 660 also receives from the air link time stamp periodic signal information that includes what local time the transmitter device 500 received any given periodic signal. Using these two pieces of information, the time stamp processor 660 can determine a correction value to convert between the reference clocks for the transmitter device 500 and the receiver device 600.

Furthermore, this correction value can be updated with each new periodic signal that arrives so that the correction value will never be too far out of date, even if the timers in the transmitter device 500 and the receiver device 600 drift with respect to each other.

In the embodiment disclosed in FIG. 6, the time stamp processor 660 instructs the receiver host interface circuit 610 when it should pull a new host interface packet 300 from the FIFO buffer 220. However, alternate embodiments could easily have the time stamp processor 660 provide a signal directly to the FIFO buffer 220 instructing it when to release its next host interface packet 300 to the receiver host interface circuit 610.

The time stamp processor 660 determines when the oldest packet in the FIFO buffer 220 should be passed to the receiver host interface circuit 610 by adding the maximum latency value to a corrected time stamp signal indicated in the oldest host interface packet. This corresponds to the earliest time that the time stamp processor 660 is relatively certain that a given host interface packet 300 must have arrived at any other device that is also receiving it. Thus, even if the current receiver device 600 has received a host interface packet 300 quickly, it will wait until the maximum expected latency time has passed before releasing the host interface packet 300 to its local host.

When the host interface circuit 610 receives a host interface packet 300, it extracts the host data packet(s) from the host interface payload 330 and sends this data onward to the host (not shown) in the receiver.

Although the information passed from the host to the transmitter host interface circuit 510 is described as being a host interface packet and the information transmitted by the wireless transceiver 530 is described as being an air link frame, the terms “frame” and “packet” can be used interchangeably, and should not be interpreted in any way as limiting the scope of the attached claims. However, for the sake of clarity in this disclosure, the term “packet” will be used to describe the signals sent from the host interface 5 10 and the term “frame” will be used to describe the signals transmitted by the wireless transceiver 530.

Furthermore, although the air link time stamp 750 is shown as being before the air link payload 430, the placement of the air link time stamp 750 with respect to the air link payload 430 can vary. The air link time stamp 740 could be placed before, after, or in the middle of the air link payload 430. In alternate embodiments, the air link time stamp 750 could even be eliminated from the air link frame 700 and be passed between a transmitter device 500 and a receiver device 600 via an alternate method. For example, the periodic signal information contained in the air link time stamp 750 could be sent between the devices using an internet connection, an infrared link, a narrowband radio connection, etc.

### Third Exemplary Embodiment

In a third exemplary embodiment the first and second exemplary embodiments can be merged. In this embodiment a time stamp is provided with each data packet sent from a host interface. Like the first exemplary embodiment, this time stamp includes a periodic signal identifier (e.g., a beacon number) and a time offset value with respect to that periodic signal identifier. However, like the second exemplary embodiment, a free-running clock can be used at the transmitting device to mark the time when each host interface is processed.

In this embodiment, the host interface packets 300 and the air link frames 400 are as described with respect to the first exemplary embodiment. However, the third exemplary embodiment allows for transmitters that use a free-running clock for time stamping as well as those that use a periodic signal value and offset for time stamping.

In order to allow these two types of devices to properly communicate, this embodiment requires a transmitter that uses the free-running clock convert the free-running time value associated with a given host interface packet into a periodic signal identifier and offset value and uses this information as a host interface packet time stamp 320, as in the first exemplary embodiment. Similarly, this embodiment requires a receiver that uses the free-running clock convert a periodic signal identifier and offset value used as a host interface packet time stamp 320 into a free-running time value.

Frequency Locking

In addition to continually synchronizing the timing for a plurality of receiver devices 200, 600, the use of time stamps synchronized to a global synchronization event also allows for the receiver devices 200, 600 to perform frequency locking.

As each receiver device 200, 600 synchronizes its local timing based on the relevant time stamp, that timing will be either correct, too slow, or too fast in comparison with a time derived from the global synchronizing event. At this time, in addition to correcting the actual timing value, the receiver device 200, 600 could also correct the timer frequency in an effort to reduce the need to make changes in the future.

If the timing value in the receiver device 200, 600 is too high, the device 200, 600 can reduce its frequency slightly to lower the speed at which its timing values rises. Similarly, if the timing value in the receiver device 200, 600 is too low, the device 200, 600 can increase its frequency slightly to raise the speed at which its timing values rises. If the receiver device 200, 600 performs this function repeatedly as it synchronizes or adjusts its timing signal, the frequency of the receiver device 200, 600 will begin to approach that of the frequency of te global synchronizing event, reducing the need for future timing adjustments.

In various embodiments the frequency adjustment function can be performed at different times. For example, it could be performed as each host interface packet is processed, or periodically as host packets are processed, at some fixed or adjustable rate.

Alternate Synchronizing Events

In the exemplary embodiments above, the synchronizing event described is shown as a periodic signal. However, the present invention should not be limited to periodic signals. Alternate embodiments can use any kind of suitable synchronizing event that all devices in a network can experience at the same time. For example, the synchronizing event could be a GPS signal, a packet or frame sent by any station in a network at irregular intervals, a signal sent via another medium such as a wired connection, or even a physical event that can be identified globally.

Furthermore, although the disclosed embodiments show two levels of encapsulation of host data (i.e., first in host interface packets 300, then in air link frames 400, 700), alternate embodiments could use more or fewer layers of encapsulation. Regardless, however, some time stamp data should be sent with the host data in some level of the encapsulation.

The circuits disclosed in FIGS. 1, 2, 5, and 6 can be implemented in a single integrated circuit in some embodiments of this invention, or can be implemented in one or more integrated circuits, one or more separate circuit elements, or even a mix of integrated circuits and separate circuit elements.

Conclusion

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A method of time stamping data in a local wireless device, comprising:
sequentially detecting a plurality of global synchronizing events;
receiving host data from a local host circuit;
forming the host data into data packets, each of the data packets including time stamp information, the time stamp information indicating when a selected one of the data packets should be processed by a remote receiver relative to other of the data packets; and
transmitting the data packets over a wireless channel to a remote wireless device,
wherein the time stamp information is identified relative to one of the plurality of global synchronizing events.

2. A method of time stamping data in a local wireless device, as recited in claim 1, wherein the global synchronizing events are one of: a plurality of network beacons sent over a wireless channel by a network coordinator, a plurality of network beacons generated by the local wireless device, a plurality of global positioning system signals sent over a wireless channel, a plurality of synchronization packets sent over a wireless channel by a remote network device, a plurality of synchronization packets generated by the local wireless device, and a plurality of synchronization signals sent over a wired channel.

3. A method of time stamping data in a local wireless device, as recited in claim 1, wherein the data packets include two or more levels of encapsulation.

4. A method of time stamping data in a local wireless device, as recited in claim 3, wherein the time stamp information includes first and second time stamp markers, the first time stamp marker being in a first of the two or more levels of encapsulation, and the second time stamp marker being in a second of the two or more levels of encapsulation.

5. A method of time stamping data in a local wireless device, as recited in claim 4,
wherein the first time stamp marker comprises a first free-running timer value corresponding to the host data, and
wherein the second time stamp marker comprises a global synchronizing event identifier and a second free-running timer value corresponding to the global synchronizing event.

6. A method of time stamping data in a local wireless device, as recited in claim 1, wherein the time stamp information comprises a global synchronizing event identifier and an offset timing value relating the host data in time with respect to the global synchronizing event.

7. A method of time stamping data in a local wireless device, as recited in claim 1, wherein the method is embodied in an integrated circuit.

8. A method of time stamping data in a local wireless device, as recited in claim 1, wherein the method is embodied in an ultrawide bandwidth transceiver.

9. A method of time stamping data in a local wireless device, as recited in claim 1, wherein the host data comprises one of: MPEG cells, encapsulated MPEG cells, Ethernet packets, internet protocol packets, and PCM audio samples.

10. A method of coordinating data in a wireless receiver, comprising:
sequentially detecting a plurality of global synchronizing events;
receiving a data packet from a remote device over a wireless channel;
extracting time stamp information from the data packet, the time stamp information indicating when the received data packet should be processed by the wireless receiver relative to other data packets;
extracting host data from the data packet; and
passing the host data to a local host in response to the time stamp information,
wherein the time stamp information is identified relative to one of the plurality of global synchronizing events.

11. A method of coordinating data in a wireless receiver, as recited in claim 10, wherein the global synchronizing events are one of: a plurality of network beacons sent over a wireless channel by a network coordinator, a plurality of network beacons generated by the local wireless device, a plurality of global positioning system signals sent over a wireless channel, a plurality of synchronization packets sent over a wireless channel by a remote network device, a plurality of synchronization packets generated by the local wireless device, and a plurality of synchronization signals sent over a wired channel.

12. A method of coordinating data in a wireless receiver, as recited in claim 10, wherein the data packets include two or more levels of encapsulation.

13. A method of coordinating data in a wireless receiver, as recited in claim 12, wherein the time stamp information includes first and second time stamp markers, the first time stamp marker being in a first of the two or more levels of encapsulation, and the second time stamp marker being in a second of the two or more levels of encapsulation.

14. A method of coordinating data in a wireless receiver, as recited in claim 13,
wherein the first time stamp marker comprises a first free-running timer value corresponding to the host data, and
wherein the second time stamp marker comprises a global synchronizing event identifier and a second free-running timer value corresponding to the global synchronizing event.

15. A method of coordinating data in a wireless receiver, as recited in claim 10, wherein the time stamp information comprises a global synchronizing event identifier and an offset timing value relating the host data in time with respect to the global synchronizing event.

16. A method of coordinating data in a wireless receiver, as recited in claim 10, wherein the method is embodied in an integrated circuit.

17. A method of coordinating data in a wireless receiver, as recited in claim 10, wherein the method is embodied in an ultrawide bandwidth transceiver.

18. A method of coordinating data in a wireless receiver, as recited in claim 10, wherein the host data comprises one of: MPEG cells, encapsulated MPEG cells, Ethernet packets, internet protocol packets, and PCM audio samples.

19. A device for transmitting host data, comprising:
a free-running timer for providing a series of increasing free-running timing values;
a host interface circuit for receiving host data from a local host circuit and a first free-running timing value from the series of increasing free-running timing values, and for placing the host data and the first free-running timing value into a host interface packet;
a detection circuit for detecting a global synchronizing event and receiving a second free-running timing value from the series of increasing free-running timing values; and
a wireless transceiver for adding the second free-running timing value and an identifier for the global synchronizing event to the host interface packet to form an air link frame, and transmitting the air link frame over a wireless channel to a remote wireless device.

20. A device for transmitting host data, as recited in claim 19, further comprising a first-in-first-out buffer located between the host interface circuit and the wireless transceiver for passing the host interface packet.

21. A device for transmitting host data, as recited in claim 19, wherein the global synchronizing event is one of: a network beacon sent over a wireless channel by a network coordinator, a network beacon generated by the wireless transceiver, a global positioning system signal sent over a wireless channel, a synchronization packet sent over a wireless channel by a remote network device, a synchronization packet generated by the wireless transceiver, and a synchronization signal sent over a wired channel.

22. A receiver device for receiving host data over a wireless channel, comprising:
a free-running timer for providing a series of increasing free-running timing values;
a detection circuit for detecting a global synchronizing event and receiving a free-running timing value from the series of increasing free-running timing values; and
a wireless transceiver for receiving an air link frame having a host interface packet and a first time stamp, the host interface packet including a second time stamp.
a first time stamp processor for receiving the first time stamp and comparing the first time stamp with a recorded free-running timing value to determine a timer correction value for the receiver device;
a second time stamp processor for receiving the second time stamp and generating a host data process signal based on the second time stamp, the correction value, and a latency value, the latency value indicating an expected maximum latency time for the air link frame over the wireless channel; and
a host interface circuit for receiving and processing the host interface frame based on the host data process signal, and providing the host data to a local host circuit.

23. A receiver device for receiving host data over a wireless channel, as recited in claim 22, further comprising a first-in-first-out buffer located between the wireless transceiver and the host interface circuit for passing the host interface packet.

24. A receiver device for receiving host data over a wireless channel, as recited in claim 22, wherein the global synchronizing event is one of: a network beacon sent over a wireless channel by a network coordinator, a network beacon generated by the wireless transceiver, a global positioning system signal sent over a wireless channel, a synchronization packet sent over a wireless channel by a remote network device, a synchronization packet generated by the wireless transceiver, and a synchronization signal sent over a wired channel.
